(19) United States
(12) Patent Application Publication
(10) Pub. No.: US 2026/0188296 A1
(43) Pub. Date: Jul. 2, 2026

(54) REAL-TIME VOICE MIXING AND GENERATION SYSTEM WITH ARTIFICIAL INTELLIGENCE

(71) Applicant: BitHuman Inc, SAN FRANCISCO, CA (US)

(72) Inventors: Mehmet Efe Akengin, EL Cerrito, CA (US); Steve Gu, Lafayette, CA (US)

(73) Assignee: BitHuman Inc, SAN FRANCISCO, CA (US)

(21) Appl. No.: 19/004,326

(22) Filed: Dec. 29, 2024

(51) Int. Cl. G10L 13/027; G10L 13/033; G10L 13/047; G10L 15/02; G10L 15/18; G10L 25/63; G10L 25/90

(52) U.S. Cl. CPC G10L 13/027; G10L 13/0335; G10L 13/047; G10L 15/02; G10L 15/1807; G10L 25/63; G10L 25/90

(57) ABSTRACT

Embodiments of the present disclosure may include a real-time voice mixing and generation system with artificial intelligence, including a processor. Embodiments may also include a multi-modal user interface input unit coupled to the processor.

### BACKGROUND OF THE INVENTION

Embodiments of the present disclosure may include a real-time voice mixing and generation system with artificial intelligence.

### BRIEF SUMMARY

Embodiments of the present disclosure may include a real-time voice mixing and generation system with artificial intelligence, including a processor. Embodiments may also include a multi-modal user interface input unit coupled to the processor. In some embodiments, the multi-modal user interface input unit may be configured to receive various types of inputs.

In some embodiments, the various types of inputs may include one or more of a first set of characteristics. In some embodiments, the one or more of the first set of characteristics may include text prompts, voice personality descriptions, images, existing voice samples, documents and websites, videos, and multi-language personality profiles.

Embodiments may also include an artificial intelligence voice-mixing engine for mixing characteristics from multiple high-quality base voices in real-time. In some embodiments, the artificial intelligence voice-mixing engine may be configured to receive various types of inputs from the multi-modal user interface input unit. In some embodiments, the various types of inputs may be configured to contain voice description, a set of characteristics of targeted audience and content to vocalize.

In some embodiments, the artificial intelligence voice-mixing engine may be configured to contain a voice library. In some embodiments, the voice library may be configured to contain a set of base voices, a set of voice characteristics. In some embodiments, the artificial intelligence voice-mixing engine may be configured to do a voice mixing process and generate a set of outputs.

In some embodiments, the voice mixing process may include a set of steps. In some embodiments, the set of steps may include voice vector selection, fine-tuning, new voice embedding. Embodiments may also include an artificial intelligence voice generation engine coupled to the processor.

In some embodiments, the artificial intelligence voice generation engine may be configured to receive the set of outputs from the artificial intelligence voice-mixing engine. In some embodiments, the artificial intelligence voice generation engine may be configured to synthesize voice with the set of outputs and generate another set of audio outputs.

Embodiments of the present disclosure may also include, the real-time voice mixing and generation system with artificial intelligence. In some embodiments, the set of steps may include weighted combination.

Embodiments of the present disclosure may also include, the real-time voice mixing and generation system with artificial intelligence. In some embodiments, the voice library may include vector representations.

Embodiments of the present disclosure may also include a method for real-time voice mixing and generating with artificial intelligence, including receiving various types of inputs through a multi-modal user interface input unit coupled to a processor. In some embodiments, the various types of inputs may include one or more of text prompts, voice personality descriptions, images, existing voice samples, documents and websites, videos, and multi-language personality profiles.

Embodiments may also include receiving various types of inputs from the multi-modal user interface input unit at an artificial intelligence voice-mixing engine. In some embodiments, the various types of input contain voice descriptions, a set of characteristics of the targeted audience, and content to vocalize. In some embodiments, the artificial intelligence voice-mixing engine contains a voice library within the artificial intelligence voice-mixing engine.

In some embodiments, the voice library may include a set of base voices and a set of voice characteristics. Embodiments may also include performing a voice mixing process within the artificial intelligence voice-mixing engine, including a set of steps of voice vector selection, fine-tuning, and new voice embedding, to generate a set of outputs. Embodiments may also include synthesizing voice with the set of outputs at an artificial intelligence voice generation engine coupled to the processor. Embodiments may also include generating another set of audio outputs based on the synthesized voice. In some embodiments, the set of steps may include weighted combination. In some embodiments, the voice library may include vector representations.

Embodiments of the present disclosure may also include a real-time voice mixing and generation system with artificial intelligence, including a processor. Embodiments may also include a multi-modal user interface input unit coupled to the processor. In some embodiments, the multi-modal user interface input unit may be configured to receive various types of inputs.

Embodiments may also include an artificial intelligence voice-mixing engine. In some embodiments, the artificial intelligence voice-mixing engine may be configured to receive various types of inputs from the multi-modal user interface input unit. In some embodiments, the various types of inputs may be configured to contain voice description, a set of characteristics of targeted audience and content to vocalize.

In some embodiments, the artificial intelligence voice-mixing engine may be configured to contain a voice library with a set of base voices. In some embodiments, the artificial intelligence voice-mixing engine may be configured to do a voice mixing process and generate a set of outputs. In some embodiments, the voice mixing process may include a set of steps.

In some embodiments, the set of steps may include voice vector selection, fine-tuning, new voice embedding. Embodiments may also include an artificial intelligence voice generation engine coupled to the processor. In some embodiments, the artificial intelligence voice generation engine may be configured to receive the set of outputs from the artificial intelligence voice-mixing engine. In some embodiments, the artificial intelligence voice generation engine may be configured to synthesize voice with the set of outputs and generate another set of audio outputs.

Embodiments of the present disclosure may also include, the real-time voice mixing and generation system with artificial intelligence. In some embodiments, the set of steps may include weighted combination.

Embodiments of the present disclosure may also include a voice vector processing system for real-time voice mixing, including a voice characteristic analyzer. In some embodiments, the voice characteristic analyzer may be configured to analyze voice characteristics including voice timbre, pitch range, speaking rate, articulation patterns, and emotional expressiveness.

Embodiments may also include generate characteristic profiles for base voices. Embodiments may also include maintain a mapping between voice characteristics and their vector representations. Embodiments may also include a feature extraction module configured to extract acoustic and prosodic features from voice inputs. Embodiments may also include generate normalized feature sets.

Embodiments may also include create voice signatures based on extracted features. Embodiments may also include a vector embedding module configured to transform voice signatures into a continuous vector space. Embodiments may also include maintain relationships between similar voice characteristics. Embodiments may also include enable interpolation between different voice styles. In some embodiments, the system enables dynamic voice characteristic manipulation and combination.

Embodiments may also include primary characteristics such as voice timbre. In some embodiments, the voice timbre may include warm, bright, dark, breathy. Embodiments may also include pitch range and baseline. Embodiments may also include speaking rate and rhythm.

Embodiments may also include articulation clarity. Embodiments may also include voice age and gender characteristics. Embodiments may also include expressive characteristics including emotional tone variations. Embodiments may also include emphasis patterns. Embodiments may also include speaking style (casual, formal, authoritative).

Embodiments may also include accent and dialect features. Embodiments may also include dynamic characteristics including volume modulation. Embodiments may also include pitch variation patterns. Embodiments may also include rhythm consistency. Embodiments may also include voice stability measures.

In some embodiments, the vector representation may include a multi-dimensional feature space where each dimension represents distinct voice characteristics. Embodiments may also include relationships between characteristics.

Embodiments may also include continuous transitions between voices. Embodiments may also include voice embeddings that capture static voice properties. Embodiments may also include dynamic speaking patterns. Embodiments may also include style-specific features. Embodiments may also include emotional expression capabilities.

Embodiments may also include voice vector selection. Embodiments may also include target voice specification through desired characteristic selection. Embodiments may also include priority weighting of characteristics. Embodiments may also include style and emotion requirements. Embodiments may also include vector matching process including similarity-based search.

Embodiments may also include characteristic-weighted selection. Embodiments may also include style-preserving combinations. Embodiments may also include selection optimization for real-time performance. Embodiments may also include quality maintenance. Embodiments may also include style consistency.

Embodiments of the present disclosure may also include a method for voice characteristic manipulation and combination, including analyzing target voice requirements. Embodiments may also include selecting appropriate base voices from the voice library. Embodiments may also include determining weighted combinations of voice characteristics. Embodiments may also include applying fine-tuning adjustments for desired effects. Embodiments may also include generating new voice embeddings based on combined characteristics.

Embodiments may also include fine-tuning that includes adjusting individual voice characteristics. Embodiments may also include optimizing characteristic combinations. Embodiments may also include preserving natural voice quality. Embodiments may also include maintaining consistency across transitions. Embodiments may also include ensuring real-time processing capability.

### BRIEF DESCRIPTION OF THE FIGURES

FIG. 1 is a block diagram illustrating a real-time voice mixing and generation system, according to some embodiments of the present disclosure.

FIG. 2 is a block illustrating diagram voice library in the real-time voice mixing and generation system, according to some embodiments of the present disclosure.

FIG. 3 is a flowchart illustrating a method, according to some embodiments of the present disclosure.

FIG. 4 is a block diagram illustrating a real-time voice mixing and generation system, according to some embodiments of the present disclosure.

FIG. 5 is a block diagram illustrating a voice vector processing system, according to some embodiments of the present disclosure.

FIG. 6 is a flowchart illustrating a method, according to some embodiments of the present disclosure.

FIG. 7 is a flowchart further illustrating the method from FIG. 6, according to some embodiments of the present disclosure.

FIG. 8 is a diagram showing a first example of a method according to some embodiments of the present disclosure.

FIG. 9 is a diagram showing a second example of a method according to some embodiments of the present disclosure.

FIG. 10 is a diagram showing a third example of a method according to some embodiments of the present disclosure.

FIG. 11 is a diagram showing a fourth example of a method according to some embodiments of the present disclosure.

FIG. 12 is a diagram showing a fifth example of a method according to some embodiments of the present disclosure.

### DETAILED DESCRIPTION

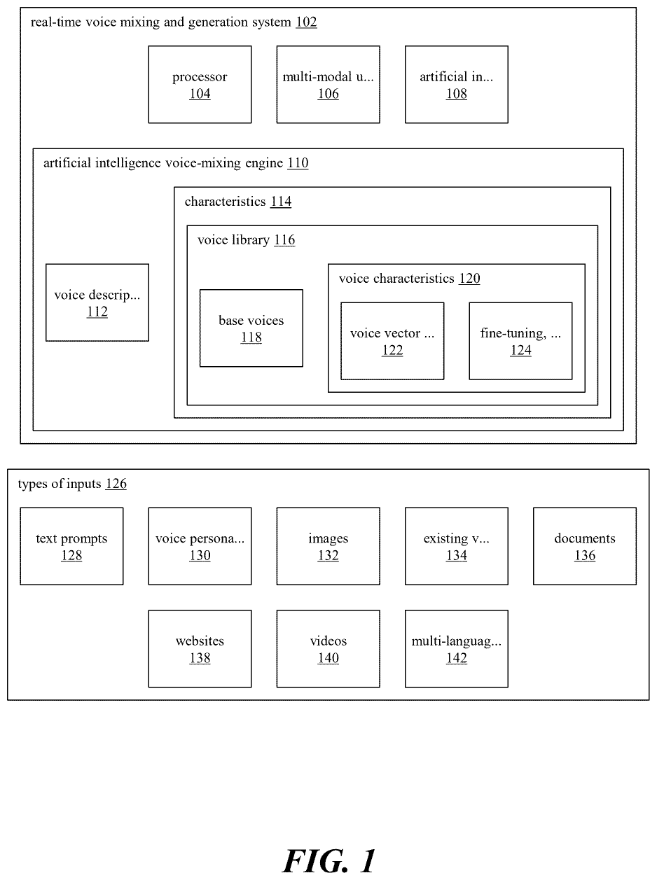

FIG. 1 is a block diagram that describes a real-time voice mixing and generation system 102, according to some embodiments of the present disclosure. In some embodiments, the real-time voice mixing and generation system 102 may include a processor 104, a multi-modal user interface input unit 106 coupled to the processor 104, an artificial intelligence voice-mixing engine 110 for mixing characteristics from multiple high-quality base voices in real-time, and an artificial intelligence voice generation engine 108 coupled to the processor 104. The multi-modal user interface input unit 106 may be configured to receive various types of inputs 126.

In some embodiments, the artificial intelligence voice-mixing engine 110 may include voice description 112 and a set of characteristics 114 of targeted audience and content to vocalize. The artificial intelligence voice-mixing engine 110 may be configured to receive various types of inputs from the multi-modal user interface input unit 106. The various types of inputs may be configured to. The set of characteristics 114 may include a voice library 116.

In some embodiments, the voice library 116 may include a set of base voices 118 and a set of voice characteristics 120. The set of voice characteristics 120 may include voice vector selection 122. The set of voice characteristics 120 may also include fine-tuning, new voice 124 embedding. The artificial intelligence voice-mixing engine 110 may be configured to do a voice mixing process and generate a set of outputs.

In some embodiments, the artificial intelligence voice generation engine 108 may be configured to receive the set of outputs from the artificial intelligence voice-mixing engine 110. The artificial intelligence voice generation engine 108 may be configured to synthesize voice with the set of outputs and generate another set of audio outputs. The types of inputs 126 may include text prompts 128, voice personality descriptions 130, images 132, existing voice samples 134, documents 136, websites 138, videos 140, and multi-language personality profiles 142.

In some embodiments, the real-time voice mixing and generation system is so configured that the set of steps further comprises weighted combination.

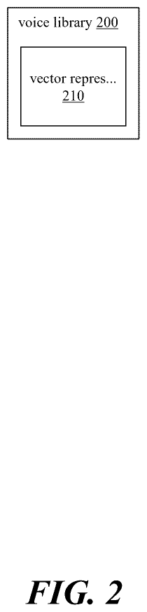

FIG. 2 is a block diagram that describes diagram voice library in the real-time voice mixing and generation system, according to some embodiments of the present disclosure. In some embodiments, within the real-time voice mixing and generation system, the voice library 200 may include vector representations 210.

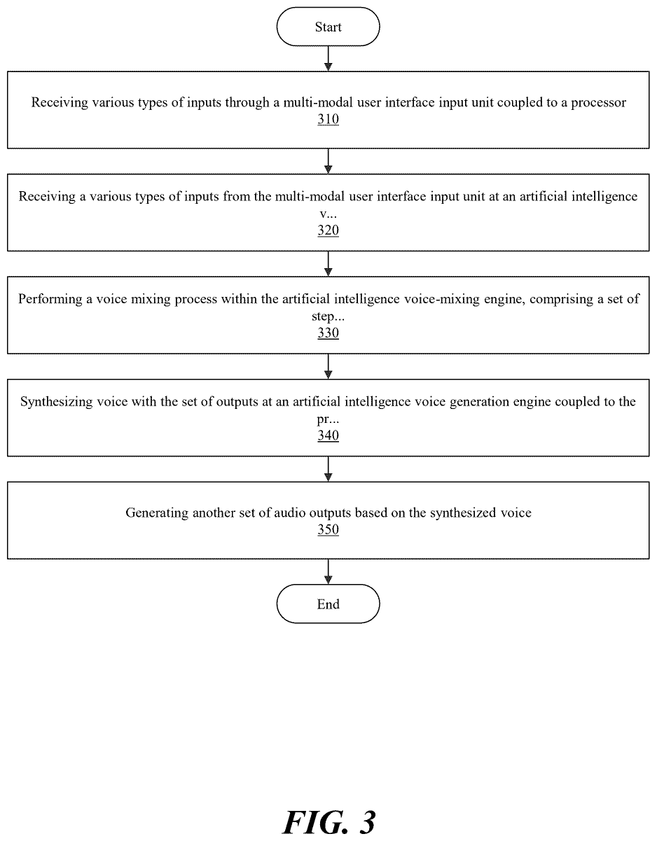

FIG. 3 is a flowchart that describes a method, according to some embodiments of the present disclosure. In some embodiments, at 310, the method may include receiving various types of inputs through a multi-modal user interface input unit coupled to a processor. At 320, the method may include receiving various types of inputs from the multi-modal user interface input unit at an artificial intelligence voice-mixing engine. At 330, the method may include performing a voice mixing process within the artificial intelligence voice-mixing engine, comprising a set of steps of voice vector selection, fine-tuning, and new voice embedding, to generate a set of outputs. At 340, the method may include synthesizing voice with the set of outputs at an artificial intelligence voice generation engine coupled to the processor. At 350, the method may include generating another set of audio outputs based on the synthesized voice.

In some embodiments, the various types of inputs may comprise one or more of text prompts, voice personality descriptions, images, existing voice samples, documents and websites, videos, and multi-language personality profiles. The various types of input may contain voice descriptions, a set of characteristics of the targeted audience, and content to vocalize. The artificial intelligence voice-mixing engine may contain a voice library within the artificial intelligence voice-mixing engine. The voice library may comprise a set of base voices and a set of voice characteristics. In some embodiments, the set of steps further comprises weighted combination. In some embodiments, the voice library may further comprise vector representations.

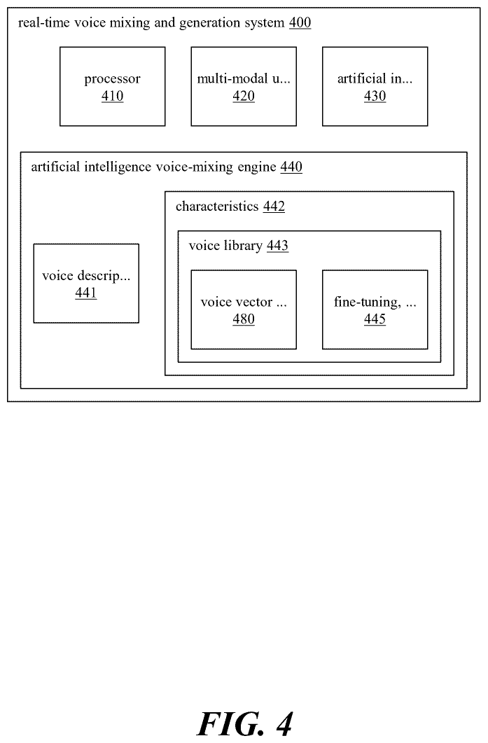

FIG. 4 is a block diagram that describes a real-time voice mixing and generation system 400, according to some embodiments of the present disclosure. In some embodiments, the real-time voice mixing and generation system 400 may include a processor 410, a multi-modal user interface input unit 420 coupled to the processor 410, an artificial intelligence voice-mixing engine 440, and an artificial intelligence voice generation engine 430 coupled to the processor 410. The multi-modal user interface input unit 420 may be configured to receive various types of inputs.

In some embodiments, the artificial intelligence voice-mixing engine 440 may include voice description 441 and a set of characteristics 442 of targeted audience and content to vocalize. The artificial intelligence voice-mixing engine 440 may be configured to receive various types of inputs from the multi-modal user interface input unit 420. The various types of inputs may be configured to. The set of characteristics 442 may include a voice library 443 with a set of base voices.

In some embodiments, the artificial intelligence voice-mixing engine 440 may be configured to. The voice library 443 may include voice vector selection 480. The voice library 443 may also include fine-tuning, new voice 445 embedding. The artificial intelligence voice-mixing engine 440 may be configured to do a voice mixing process and generate a set of outputs. The voice mixing process. A set of steps. The set of steps. The artificial intelligence voice generation engine 430 may be configured to receive the set of outputs from the artificial intelligence voice-mixing engine 440. The artificial intelligence voice generation engine 430 may be configured to synthesize voice with the set of outputs and generate another set of audio outputs.

In some embodiments, the real-time voice mixing and generation system is so configured that the set of steps further comprises weighted combination.

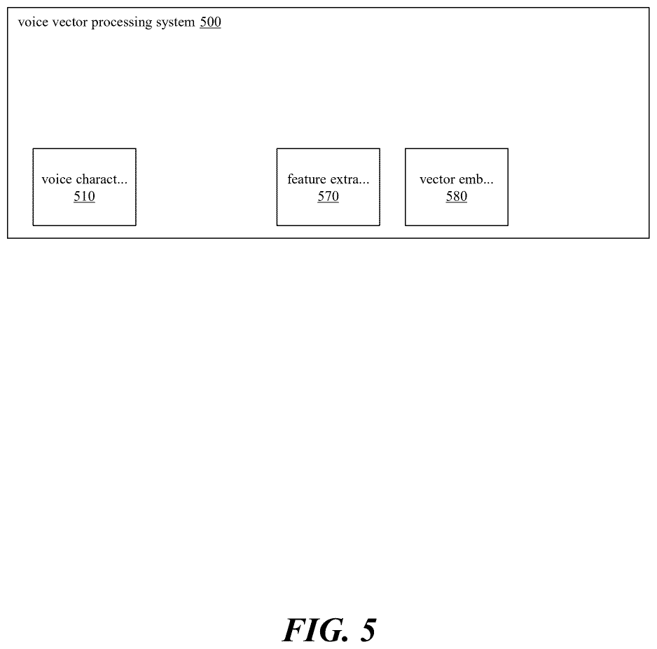

FIG. 5 is a block diagram that describes a voice vector processing system 500, according to some embodiments of the present disclosure. In some embodiments, the voice vector processing system 500 may include a voice characteristic analyzer 510, a feature extraction module 570, and a vector embedding module 580.

In some embodiments, the voice characteristic analyzer 510 is configured to: analyze voice characteristics including voice timbre, pitch range, speaking rate, articulation patterns, generate characteristic profiles for base voices and maintain a mapping between voice characteristics and their vector representations.

In some embodiments, the feature extraction module 570 is configured to: extract acoustic and prosodic features from voice inputs; generate normalized feature sets; create voice signatures based on extracted features.

In some embodiments, a vector embedding module 580 is configured to: transform voice signatures into a continuous vector space; maintain relationships between similar voice characteristics; enable interpolation between different voice styles, wherein the system enables dynamic voice characteristic manipulation and combination.

In some embodiments, the present disclosure is configured to generate characteristic profiles for base voices, maintain a mapping between voice characteristics and their vector representations, extract acoustic and prosodic features from voice may input. generate normalized feature sets, create voice signatures based on extracted features, transform voice signatures into a continuous vector space, maintain relationships between similar voice characteristics, enable interpolation between different voice styles. The system 500 may enable dynamic voice characteristic manipulation and combination.

In some embodiments, voice characteristics comprise: primary characteristics including: voice timbre, wherein the voice timbre comprises warm, bright, dark, breathy; pitch range and baseline; speaking rate and rhythm; articulation clarity; voice age and gender characteristics; expressive characteristics including: emotional tone variations; emphasis patterns; speaking style (casual, formal, authoritative); accent and dialect features; dynamic characteristics including: volume modulation; pitch variation patterns; rhythm consistency; voice stability measures.

In some embodiments, the vector representation comprises: a multi-dimensional feature space where: each dimension represents distinct voice characteristics; relationships between characteristics are preserved; similar voices cluster together naturally; transitions between voices are continuous; voice embeddings that capture: static voice properties; dynamic speaking patterns; style-specific features; emotional expression capabilities.

In some embodiments, the voice vector selection comprises: target voice specification through: desired characteristic selection; priority weighting of characteristics; style and emotion requirements; vector matching process including: similarity-based search; characteristic-weighted selection; style-preserving combinations; selection optimization for: real-time performance; quality maintenance; style consistency.

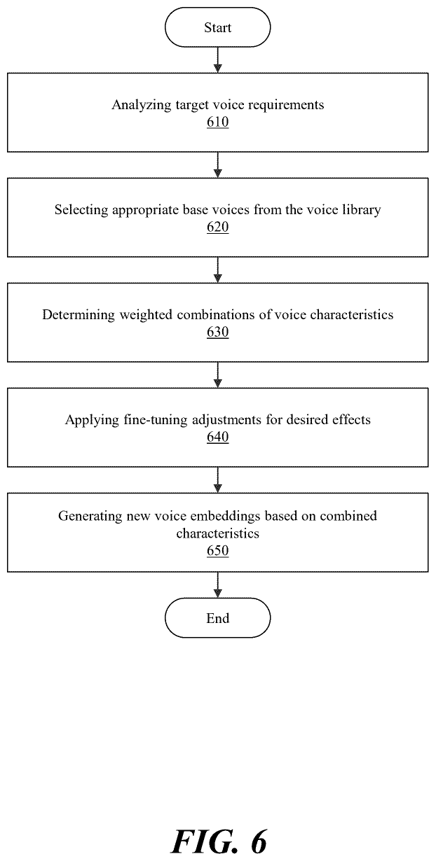

FIG. 6 is a flowchart that describes a method, according to some embodiments of the present disclosure. In some embodiments, at 610, the method may include analyzing target voice requirements. At 620, the method may include selecting appropriate base voices from the voice library. At 630, the method may include determining weighted combinations of voice characteristics. At 640, the method may include applying fine-tuning adjustments for desired effects. At 650, the method may include generating new voice embeddings based on combined characteristics.

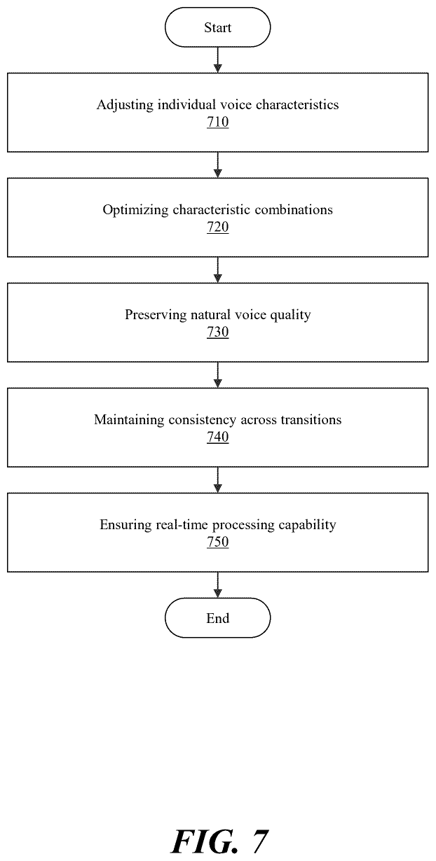

FIG. 7 is a flowchart that further describes the method from FIG. 6, according to some embodiments of the present disclosure. In some embodiments, applying fine-tuning adjustments further comprises a step 710 of adjusting individual voice characteristics.

In some embodiments, applying fine-tuning adjustments further comprises a step 720 of optimizing characteristic combination. In some embodiments, applying fine-tuning adjustments further comprises a step 730 of preserving natural voice quality. In some embodiments, applying fine-tuning adjustments further comprises a step 740 of maintaining consistency across transitions. In some embodiments, applying fine-tuning adjustments further comprises a step 750 of ensuring real-time processing capability.

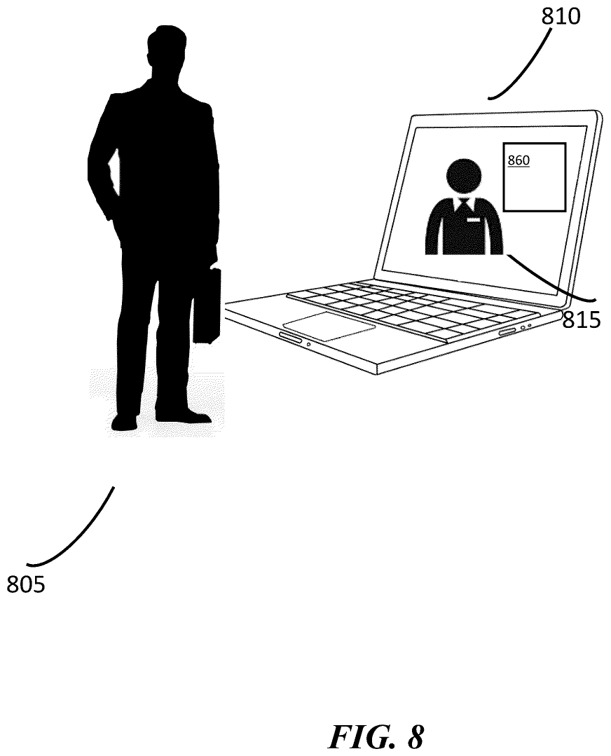

FIG. 8 is a diagram showing a first example of a method according to some embodiments of the present disclosure where a visual AI agent is configure to help the real-time voice mixing and generation process.

In some embodiments, a user 805 can approach a smart display 810. In some embodiments, the smart display 810 could be LED or OLED-based. In some embodiments, the display 810 could be a part of a desktop computer, a laptop computer, or a tablet computer. In some embodiments, a camera, sensor, and microphone are attached to the smart display 810. In some embodiments, an artificial intelligence visual assistant 815 with customer-facing duty is active on the smart display 810. In some embodiments, the artificial intelligent agent 815 may help in generating real-time voice with AI. In some embodiments, a leading visual agent is guiding the artificial intelligence visual assistant with customer-facing duty 815 without the knowledge of the artificial intelligence visual assistant with customer-facing duty 815. In some embodiments, a visual working agenda 860 is shown on the smart display 810. In some embodiments, user 805 can approach the smart display 810 and initiate and complete the business process with the visual assistant 815 by the methods described in FIG. 1-FIG. 7. In some embodiments, a keyboard is coupled to a central processor. In some embodiments, a keyboard is coupled to a server via a wireless link. In some embodiments, user 805 can interact with the visual assistant 815 via a camera, sensor and microphone using methods described in FIG. 1-FIG. 7, with the help of the keyboard. In some embodiments, user 805 can choose what language to use. In some embodiments, other users can use this service described in this paragraph. In some embodiments, other users can use this service described in this paragraph. In some embodiments, the user can interact with multiple AI visual assistants as described in this example and the system and methods described in FIG. 1-7.

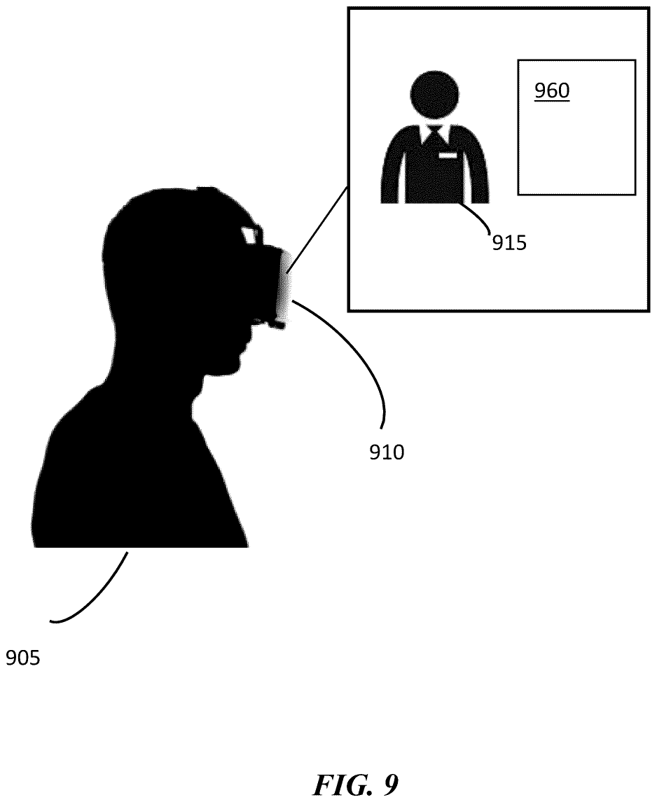

FIG. 9 is a diagram showing a second example of a method according to some embodiments of the present disclosure where a visual AI agent is configure to help the real-time voice mixing and generation process.

In some embodiments, a user 905 can view programs including news with a VR or AR device 910. In some embodiments, a processor and a server are connected to the VR or AR device 910. In some embodiments, an interactive keyboard is connected to the VR or AR device 910. In some embodiments, an AI visual assistant 915 with customer-facing duty is active on the VR or AR device 910. In some embodiments, a leading visual agent is guiding the AI visual assistant with customer-facing duty 915 without the knowledge of the AI visual assistant with customer-facing duty 915. In some embodiments, the artificial intelligent agent 915 may help in generating real-time voice with AI. In some embodiments, a visual working agenda 960 is shown on the VR or AR 910. In some embodiments, user 905 can initiate and complete the business process with the visual assistant 905 via the VR or AR device 915 by the methods described in FIG. 1-FIG. 7. In some embodiments, an interactive panel is coupled to a central processor. In some embodiments, an interactive panel is coupled to a server via a wireless link. In some embodiments, the user 905 can choose what language to use. In some embodiments, other users can use this service described in this paragraph. In some embodiments, other users can use this service described in this paragraph. In some embodiments, the user can interact with multiple AI visual assistants as described in this example and the system and methods described in FIG. 1-7.

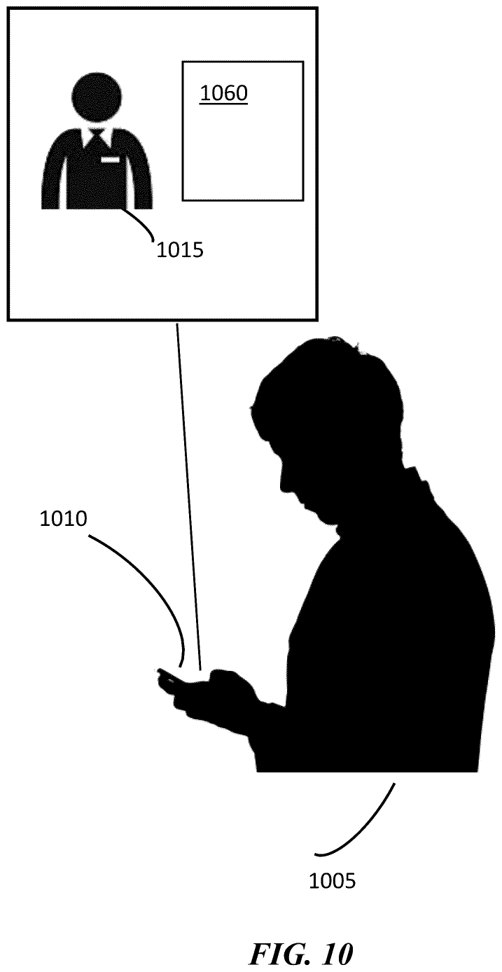

FIG. 10 is a diagram showing a third example of a method according to some embodiments of the present disclosure where a visual AI agent is configure to help the real-time voice mixing and generation process.

In some embodiments, a user 1005 can view programs including news with a smartphone device 1010. In some embodiments, a processor and a server are connected to the smartphone device 1010. In some embodiments, an interactive keyboard is connected to the smartphone device 1010. In some embodiments, an AI visual assistant 1015 with customer-facing duty is active on the smartphone device 1010. In some embodiments, a leading visual agent is guiding the AI visual assistant with customer-facing duty 1015 without the knowledge of the AI visual assistant with customer-facing duty 1015. In some embodiments, the artificial intelligent agent 1015 may help in generating real-time voice with AI. In some embodiments, a visual working agenda 1060 is shown on the smartphone device 1010. In some embodiments, user 1005 can initiate and complete the business process with the visual assistant 1015 via smartphone device 1010 by the methods described in FIG. 1-FIG. 7. In some embodiments, an interactive panel is coupled to a central processor. In some embodiments, interactive panel is coupled to a server via a wireless link. In some embodiments, the user 1005 can choose what language to be used. In some embodiments, other users can use this service described in this paragraph. In some embodiments, other users can use this service described in this paragraph. In some embodiments, the user can interact with multiple AI visual assistants as described in this example and the system and methods described in FIG. 1-7.

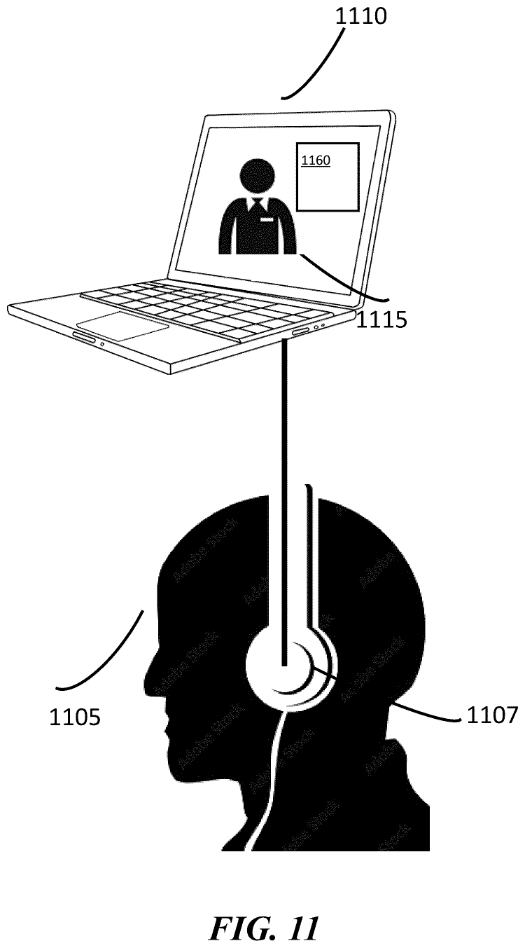

FIG. 11 is a diagram showing a fourth example of a method according to some embodiments of the present disclosure where a visual AI agent is configure to help the real-time voice mixing and generation process.

In some embodiments, a user 1105 has a brain-computer interface. In some embodiments, the user 1105 may wear a headset 1107 that can detect and translate the electric signal from the brain and communicate with the computer or other devices. The computer 1110 or other devices relate to a cable or wire to the headset. In some embodiments, a processor and a server are connected to the computer 1110. In some embodiments, an interactive keyboard is connected to the computer 1110. In some embodiments, an AI visual assistant 1115 with customer-facing duty is active on the computer 1110. In some embodiments, the artificial intelligent agent 1115 may help in generating real-time voice with AI. In some embodiments, a leading visual agent is guiding the AI visual assistant with customer-facing duty 1115 without the knowledge of the AI visual assistant with customer-facing duty 1115. In some embodiments, a visual working agenda 1160 is shown on the computer 1110. In some embodiments, user 1105 can initiate and complete the business process with the visual assistant 1105 via the computer 1115 by the methods described in FIG. 1-FIG. 7. In some embodiments, an interactive panel is coupled to a central processor. In some embodiments, an interactive panel is coupled to a server via a wireless link. In some embodiments, the user 1105 can choose what language to use. In some embodiments, other users can use this service described in this paragraph. In some embodiments, other users can use this service described in this paragraph. In some embodiments, the user can interact with multiple AI visual assistants as described in this example and the system and methods described in FIG. 1-7.

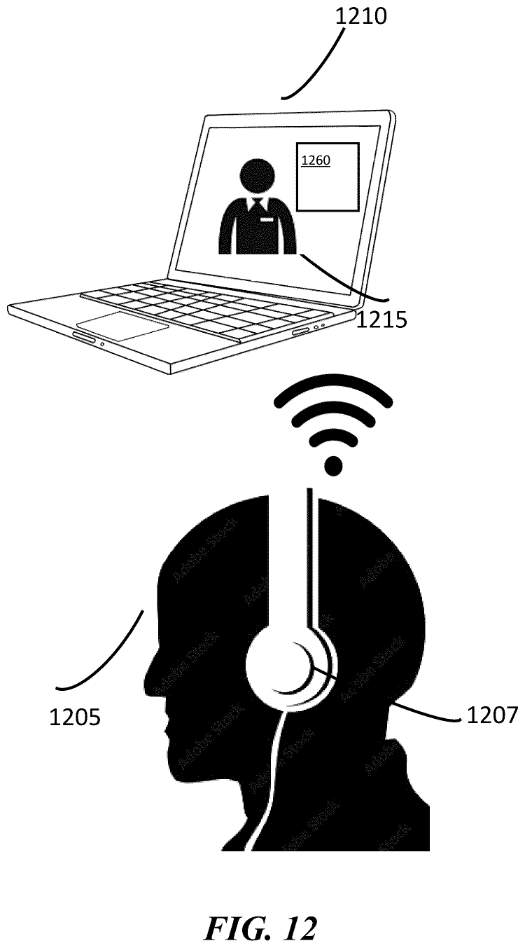

FIG. 12 is a diagram showing a fifth example of a method according to some embodiments of the present disclosure where a visual AI agent is configure to help the real-time voice mixing and generation process.

In some embodiments, a user 1205 has a brain-computer interface. In some embodiments, the user 1205 may wear a headset 1207 that can detect and translate the electric signal from the brain and communicate with the computer or other devices. The computer 1210 or other devices relate to wireless means to the headset. In some embodiments, a processor and a server are connected to the computer 1210. In some embodiments, an interactive keyboard is connected to the computer 1210. In some embodiments, an AI visual assistant 1215 with customer-facing duty is active on the computer 1210. In some embodiments, a leading visual agent is guiding the AI visual assistant with customer-facing duty 1215 without the knowledge of the AI visual assistant with customer-facing duty 1215. In some embodiments, the artificial intelligent agent 1215 may help in generating real-time voice with AI. In some embodiments, a visual working agenda 1260 is shown on the computer 1210. In some embodiments, user 1205 can initiate and complete the business process with the visual assistant 1205 via the computer 1215 by the methods described in FIG. 1-FIG. 7. In some embodiments, an interactive panel is coupled to a central processor. In some embodiments, an interactive panel is coupled to a server via a wireless link. In some embodiments, the user 1205 can choose what language to use. In some embodiments, other users can use this service described in this paragraph. In some embodiments, other users can use this service described in this paragraph. In some embodiments, the user can interact with multiple AI visual assistants as described in this example and the system and methods described in FIG. 1-7.

1. A real-time voice mixing and generation system with artificial intelligence, comprising:
a processor;
a multi-modal user interface input unit coupled to the processor, wherein the multi-modal user interface input unit is configured to receive various types of inputs, wherein the various types of inputs comprise one or more of a first set of characteristics, wherein the one or more of the first set of characteristics comprise text prompts, voice personality descriptions, images, existing voice samples, documents and websites, videos, and multi-language personality profiles;
an artificial intelligence voice-mixing engine for mixing characteristics from multiple high-quality base voices in real-time, wherein the artificial intelligence voice-mixing engine is configured to from the multi-modal user interface input unit, wherein the various types of inputs are configured to contain voice description, a set of characteristics of targeted audience and content to vocalize, wherein the artificial intelligence voice-mixing engine is configured to contain a voice library, wherein the voice library is configured to contain a set of base voices, a set of voice characteristics, wherein the artificial intelligence voice-mixing engine is configured to do a voice mixing process and generate a set of outputs, wherein the voice mixing process comprises a set of steps, wherein the set of steps comprises voice vector selection, fine-tuning, new voice embedding; and
an artificial intelligence voice generation engine coupled to the processor, wherein the artificial intelligence voice generation engine is configured to receive the set of outputs from the artificial intelligence voice-mixing engine, wherein the artificial intelligence voice generation engine is configured to synthesize voice with the set of outputs and generate another set of audio outputs.

2. The real-time voice mixing and generation system with artificial intelligence of claim 1,
wherein the set of steps further comprises weighted combination.

3. The real-time voice mixing and generation system with artificial intelligence of claim 1,
wherein the voice library further comprises vector representations.

4. A method for real-time voice mixing and generating with artificial intelligence,
comprising:
receiving various types of inputs through a multi-modal user interface input unit coupled to a processor, wherein the various types of inputs comprise one or more of text prompts, voice personality descriptions, images, existing voice samples, documents and websites, videos, and multi-language personality profiles;
receiving a various types of inputs from the multi-modal user interface input unit at an artificial intelligence voice-mixing engine, wherein the various types of input contains voice descriptions, a set of characteristics of the targeted audience, and content to vocalize, wherein the artificial intelligence voice-mixing engine contains a voice library within the artificial intelligence voice-mixing engine, wherein the voice library comprises a set of base voices and a set of voice characteristics;
performing a voice mixing process within the artificial intelligence voice-mixing engine, comprising a set of steps of voice vector selection, fine-tuning, and new voice embedding, to generate a set of outputs;
synthesizing voice with the set of outputs at an artificial intelligence voice generation engine coupled to the processor; and
generating another set of audio outputs based on the synthesized voice.

5. The method for real-time voice mixing and generating with artificial intelligence of claim 4, wherein the set of steps further comprises weighted combination.

6. The method for real-time voice mixing and generating with artificial intelligence of claim 4, wherein the voice library further comprises vector representations.

7. A real-time voice mixing and generation system with artificial intelligence, comprising:
a processor;
a multi-modal user interface input unit coupled to the processor, wherein the multi-modal user interface input unit is configured to receive various types of inputs;
an artificial intelligence voice-mixing engine, wherein the artificial intelligence voice-mixing engine is configured to from the multi-modal user interface input unit, wherein the various types of inputs are configured to contain voice description, a set of characteristics of targeted audience and content to vocalize, wherein the artificial intelligence voice-mixing engine is configured to contain a voice library with a set of base voices, wherein the artificial intelligence voice-mixing engine is configured to do a voice mixing process and generate a set of outputs, wherein the voice mixing process comprises a set of steps, wherein the set of steps comprises voice vector selection, fine-tuning, new voice embedding; and
an artificial intelligence voice generation engine coupled to the processor, wherein the artificial intelligence voice generation engine is configured to receive the set of outputs from the artificial intelligence voice-mixing engine, wherein the artificial intelligence voice generation engine is configured to synthesize voice with the set of outputs and generate another set of audio outputs.

8. The real-time voice mixing and generation system with artificial intelligence of claim 7,
wherein the set of steps further comprises weighted combination.

9. A voice vector processing system for real-time voice mixing, comprising:
a voice characteristic analyzer, wherein the voice characteristic analyzer is configured to:
analyze voice characteristics including voice timbre, pitch range, speaking rate, articulation patterns, and emotional expressiveness;
generate characteristic profiles for base voices;
maintain a mapping between voice characteristics and their vector representations;
a feature extraction module configured to:
extract acoustic and prosodic features from voice inputs;
generate normalized feature sets;
create voice signatures based on extracted features;
a vector embedding module configured to:
transform voice signatures into a continuous vector space;
maintain relationships between similar voice characteristics;
enable interpolation between different voice styles;
wherein the system enables dynamic voice characteristic manipulation and combination.

10. The voice vector processing system of claim 9, wherein voice characteristics comprise:
primary characteristics including:
voice timbre, wherein the voice timbre comprises warm, bright, dark, breathy;
pitch range and baseline;
speaking rate and rhythm;
articulation clarity;
voice age and gender characteristics;
expressive characteristics including:
emotional tone variations;
emphasis patterns;
speaking style (casual, formal, authoritative);
accent and dialect features;
dynamic characteristics including:
volume modulation;
pitch variation patterns;
rhythm consistency;
voice stability measures.

11. The voice vector processing system of claim 10, wherein the vector representation comprises:
a multi-dimensional feature space where:
each dimension represents distinct voice characteristics;
relationships between characteristics are preserved;
similar voices cluster together naturally;
transitions between voices are continuous;
voice embeddings that capture:
static voice properties;
dynamic speaking patterns;
style-specific features;
emotional expression capabilities.

12. The voice vector processing system of claim 9, wherein voice vector selection comprises:
target voice specification through:
desired characteristic selection;
priority weighting of characteristics;
style and emotion requirements;
vector matching process including:
similarity-based search;
characteristic-weighted selection;
style-preserving combinations;
selection optimization for:
real-time performance;
quality maintenance;
style consistency.

13. A method for voice characteristic manipulation and combination, comprising:
analyzing target voice requirements;
selecting appropriate base voices from the voice library;
determining weighted combinations of voice characteristics;
applying fine-tuning adjustments for desired effects;
generating new voice embeddings based on combined characteristics.

14. The method of claim 13, wherein applying fine-tuning adjustments further comprises:
adjusting individual voice characteristics;
optimizing characteristic combinations;
preserving natural voice quality;
maintaining consistency across transitions;
ensuring real-time processing capability.
